(19) United States
(12) Patent Application Publication
(10) Pub. No.: US 2005/0133487 A1
(43) Pub. Date: Jun. 23, 2005

(54) Cutting tool and a method for the manufacture thereof

(75) Inventors: Leif Nystrom, Jarbo (SE); Lars Matiasson, Osthammar (SE); Kenth Eriksson, Gimo (SE)

Correspondence Address: BURNS DOANE SWECKER & MATHIS L L P, POST OFFICE BOX 1404, ALEXANDRIA, VA, 22313-1404, US

(73) Assignee: SANDVIK AB, Sandviken (SE)

(21) Appl. No.: 10/965,206

(22) Filed: Oct. 15, 2004

(30) Foreign Application Priority Data
Oct. 16, 2003 (SE) 0302728-1

(51) Int. Cl. B23K 26/28

(52) U.S. Cl. 219/121.64

(57) ABSTRACT

A tool for chip-removing machining includes first and second metallic parts, and a metallic shim disposed within a gap between those parts. An outer periphery of the shim is exposed. A laser welding procedure is performed around the exposed outer periphery of the shim to weld the shim to the first and second parts. The procedure involves positioning a welder in a first position to weld the shim to one of the first and second parts, and then repositioning the welder to a second position to weld the shim to the other of the first and second parts.

The present application claims priority under 35 U.S.C. § 119 to Patent Application Serial No. 0302728-1 filed in Sweden on Oct. 16, 2003, the content of which is hereby incorporated by reference.

### TECHNICAL FIELD OF THE INVENTION

In a first aspect, this invention relates to a method for the manufacture of tools that are intended for chip-removing machining, which tools comprise two metallic parts permanently united via an interface. In a second aspect, the invention also relates to a tool, intended for cutting or chip-removing machining of primarily metal, of the type that comprises a metallic coupling part and a second metallic part permanently united to the same via an interface.

### PRIOR ART

Tools of the above generally mentioned kind are found within all three main areas of the field of cutting machining, i.e., drilling, milling and turning. Within the two first-mentioned areas, the tools are of a rotary character and useful for the machining of fixed as well as movable workpieces, while tools for turning are fixed and have the purpose of machining rotary workpieces. The basis of the present invention is problems that have been observed within the range of rotary cutting tools, particularly drills. However, this does not preclude that the solution described henceforth can be applied to turning tools.

For many different reasons, modern drills are made of a more sophisticated type by assembly of a coupling part with a working part. The coupling part is compatible with a certain type of machine tool or tool holder, i.e., it has a shape that corresponds to the shape of the tool holder. The insert-carrying working part is in the form of a shank formed with chip and cooling-medium channels, on the free end of which cutting inserts or so-called loose tops can releasably be mounted. The shank and the coupling part are united permanently to each other via an interface between the rear end of the shank and the front end of the coupling part. Used as a single permanent joint between the shank and the coupling part, a male-female joint having a press-fit. More precisely, the shank is formed at the rear end thereof with a male member in the form of a spigot, which is pressed into a seating formed in the front end of the coupling part, not rarely at the same time as the seating is widened by heating the coupling part and then is shrunk by cooling. In order to be able to transfer the requisite torque between the coupling part and the shank with a sufficient safety margin, the male spigot and the seating must have a considerable axial extension with the purpose of establishing a sufficiently great contact surface between each other. Therefore, in most cases, the axial length of the male spigot has been at least 1.5 times greater than the diameter of the drill shank. The fact that the male spigot has been of considerable length has naturally resulted in the drilling tool in question in its entirety being of a great total length; something that in practice implies a plurality of disadvantages. Besides a great dead weight, high consumption of material in the manufacture and extra great space requirements in connection with storage and transportation, the great length of the drilling tool has meant a tendency of the tool to be set in vibration because this phenomenon easier arises the longer and slender the same is.

Against the above background, ways have recently been sought to shorten, with maintained performance of transmission of torque, the spigot and seating, respectively, of the male-female joint upon the greatest possible reduction of the total length of the drilling tool. In this connection, the possibility of also providing, in addition to a male-female joint, a welded joint between the shank and the coupling part has been considered. Thus, a plurality of experiments have been made to weld together said components by means of conventional welding technique, which makes use of supply of material during simultaneous supply of heat. Tests with MIG welding as well as TIG welding have, however, turned out to be unfruitful, among other things, as a consequence of hydrogen embrittlement in the interface between the components and mediocre or unacceptable precision, so far that the exact positioning of the cutting inserts in relation to the coupling part was lost.

### OBJECTS AND FEATURES OF THE INVENTION

In a first aspect, the present invention aims at obviating the above-mentioned drawbacks in previously known cutting tools of rotatable type, such as drills and milling cutters, and at providing an improved tool as well as an improved method for the manufacture of cutting tools. Thus, a primary object of the invention is to create conditions for welding together two metallic parts included in a cutting tool, in particular parts of steel, with high accuracy so far that the inevitable heat release during a welding operation must not lead to any deformations or material changes of the type that could dislodge the two parts from an exact, predetermined set position in relation to each other. An additional object is to enable realization of a welded joint, which by virtue of the position thereof in the tool can be utilized in an optimal way in respect of the capacity thereof to transfer forces between the two tool parts. Another object, related to rotatable cutting tools, such as drills and milling cutters, is to provide a tool having a minimal length and simultaneously maintained or even improved strength and rigidity, with the utmost intention that the tool during operation should give improved machining precision.

According to the invention, at least the primary object is attained by a method forming manufacturing a tool for chip-removing machining. The tool includes first and second metallic parts. The method comprises the steps of:
A) positioning a metallic shim within a gap between the first and second parts, such that an outer periphery of the shim is exposed, and
B) performing a laser welding procedure around the exposed outer periphery of the shim to weld the shim to the first and second parts.

In another aspect, the invention also relates to an improved cutting tool as such by application of the method according to the invention. The new tool according to the invention comprises a metallic first part, a metallic second part, and a metallic shim disposed in a gap between the first and second parts. The shim has a shape generally corresponding to a shape of the gap. The shim includes a first side laser welded to the first part, and a second opposite side laser welded to the second part.

The invention is based on the idea to apply a shim in a gap between two tool parts that should be welded together, which shim has a predetermined and substantially invariable shape corresponding to the shape of the gap, and which in a cool state is welded along the periphery thereof by means of at least one laser beam, which at a considerable speed is caused to be moved along the shim, the laser beam during the movement thereof in relation to the shim and surrounding portions of the tool parts melting the metal in the shim and the tool parts, respectively, in very limited, almost point-like areas, the size of which is determined by the diameter of the beam (spot size). In such a way, welding and the ensuing heat release take place very locally in a point area, which quickly is moved along the shim; something which ensures that heat deformations, heat embrittlement and the like, do not arise in the interfaces or contact surfaces between the shim and the tool parts. During experiments that form the basis of the invention, it has accordingly been possible to observe that the tool immediately after finalized welding is so cool that the weld quite easily could be touched by a hand. Applied to a rotatable cutting tool, the invention can in an advantageous way be utilized with the purpose of reducing the tool length, at the same time as the strength of the tool in respect of the capacity of transmission of force or torque in an interface between two composed parts, e.g. a coupling part and a drill shank, not only is maintained but even can be improved.

Additional Elucidation of Prior Art

Welding together metal parts in general by means of laser welding is well known, per se, e.g. from British Patent 2,344,549, U.S. Pat. No. 5,343,014, French Patent No. 2,656,556, EP 0 491 959 and JP-58090389. However, no one of the welding procedures, which are accounted for in the same publications, utilizes the inventive principle of applying a separate, metallic shim in a gap opening peripherically, which shim is of a predetermined and invariable shape, and then by means of a quickly movable laser beam weld the periphery of the shim exposed outward.

### BRIEF DESCRIPTION OF THE DRAWINGS

The objects and advantages of the invention will become apparent from the following detailed description of preferred embodiments thereof in connection with the accompanying drawings, in which like numerals designate like elements, and in which

FIG. 1 is a perspective view taken obliquely from behind a cutting tool in the form of a drill made in accordance with the invention,

FIG. 2 is a perspective exploded view of the drill of FIG. 1 taken obliquely from the front,

FIG. 3 is an exploded view taken straight from the side of the same drill,

FIG. 4 is a schematic, partial side view of an enlarged interface between a coupling part and a shank included in the drill, the interface being shown without any shim,

FIG. 5 is a side view of the interface of FIG. 4 during a first welding operation,

FIG. 6 is an analogous side view during a second welding operation,

FIG. 7 is a perspective view of a turning tool, more precisely a slotting tool, a coupling part, and a second part in the form of a so-called serration plate, which is welded to the coupling part in accordance with the method according to the invention,

FIG. 8 is a perspective exploded view of the tool according to FIG. 6,

FIG. 9 is an additional exploded view of just the coupling part and the serration plate as well as a shim therebetween, and

FIG. 10 is a perspective view of the back side of the serration plate.

### DESCRIPTION OF PREFERRED EMBODIMENTS OF THE INVENTION

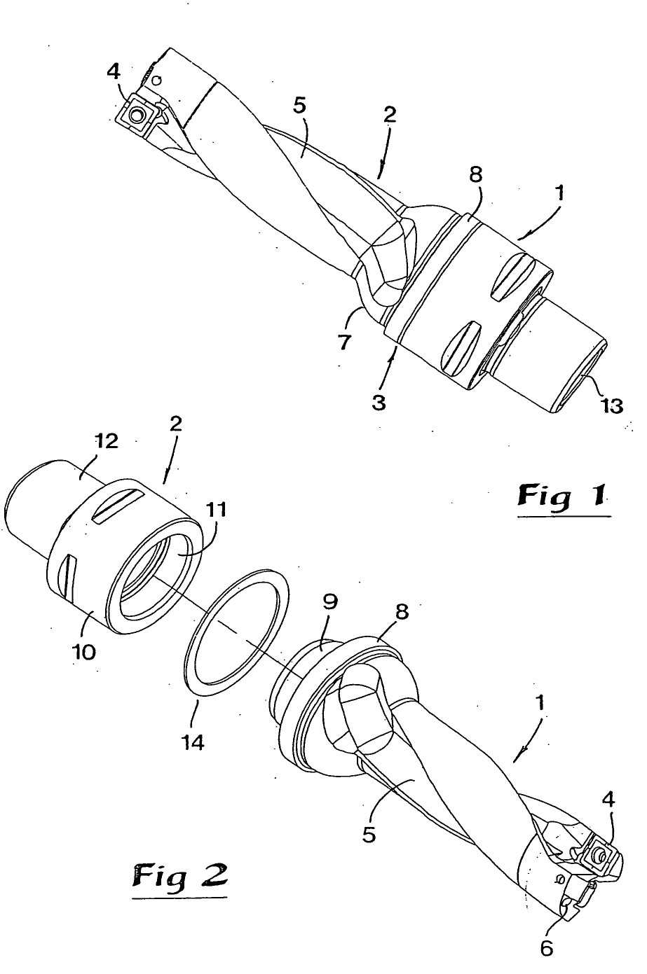

As has been mentioned by way of introduction, the problems that form the basis of the present invention are primarily associated with rotatable cutting tools, one type of which, viz, a drill, is represented in FIGS. 1-5. Said drill includes a coupling part 1, as well as a second part in the form of a shank 2 permanently united to the same via an interface 3. The shank 2 has a cylindrical, long narrow basic shape and is at the free, front end thereof formed with seatings or so-called insert pockets for releasable, replaceable cutting inserts 4. In the envelope surface of the shank, chip channels 5 are formed for evacuation of chips, which are separated by the cutting inserts 4. Internally in the shank, there are also cooling-liquid channels 6, which mouth in the tip of the shank and have the purpose of cooling the cutting inserts. At the rear end thereof, the shank transforms via a successively thickened transition portion 7 in a collar 8, the envelope surface of which is cylindrical. Rearward from this collar, a male member (projection) 9 extends in the form of a spigot, which likewise has a cylindrical envelope surface. Although said male member commonly is denominated a spigot, the same may include an internal cavity in which cooling liquid, which is fed via the coupling part, is received to be forward out in the cooling-liquid channels 6.

A front part 10 of the coupling part 12 has a cylindrical basic shape and includes an internal, female-like seating (socket) 11, which is delimited by a cylindrical surface having substantially the same inner diameter as the outer diameter of the male spigot 9. At the rear, the cylinder part or the sleeve 10 transforms into a coupling piece 12, the shape of which, more precisely the cross-section shape, is adapted to the shape of the tool holder in which the drill is intended to be fixed. A type of coupling piece usually occurring on the market is known under the denomination COROMANT CAPTO®. However, also a number of other types of coupling pieces are found depending on the machine equipment of the user. It should be observed that the coupling part 2 is hollow throughout, so that the cooling liquid may be fed in from the tool holder via a rear opening 13.

The above-mentioned spigot 9 and the seating 11 together form a male-female joint, which by means of press fit and/or shrink fit in a previously known way permanently unites the shank to the coupling part. The joint may be established by heating the coupling part, and then, after pressing-in of the spigot 9 in the seating 11, the same is allowed to cool down, so that the seating shrinks. In order to allow, with a certain safety margin, transfer of a torque between the coupling part and the shank that is prescribed for the individual drill, previously in the art the male spigot 9 and the seating 11 have had a considerable length or axial extension in order to, in such a way, present a sufficiently large, force-transferring contact surface. In practice, the length of the male spigot has accordingly heretofore amounted to at least 1.5 times the diameter of the drill.

Furthermore, it should be mentioned that the coupling part as well as the shank generally are made from steel. Thus, in the shank 2, a steel of the type SS 142225 is advantageously used, which is a low-alloy heat-treatment steel having good weldability, and which, in addition to such alloy materials as Si, Mn, S, Cr and Mo, contains 0.22 to 0.29% of coal (C). However, in the coupling part 1, a steel of the type THG 2000 is used, which is a chrome-molybdenum-vanadium-alloyed steel developed for, among other things, drills and milling bodies, the carbon content of which is within the range of 0.35 to 0.42%. Experiments to weld the two drill parts 1, 2 of such a steel by means of conventional welding, such as MIG welding or TIG welding, have failed.

So far, the drill shown in FIGS. 1-3 has been described hitherto, the same is in all essentials previously known.

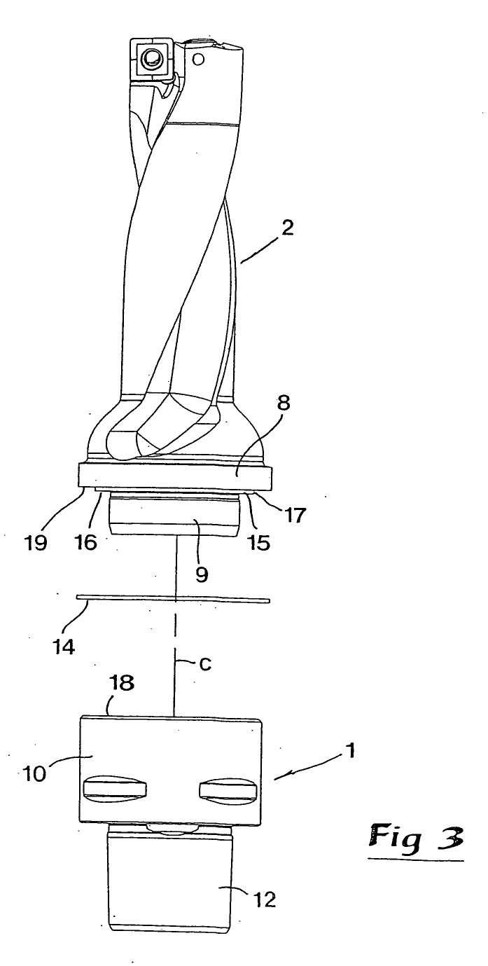

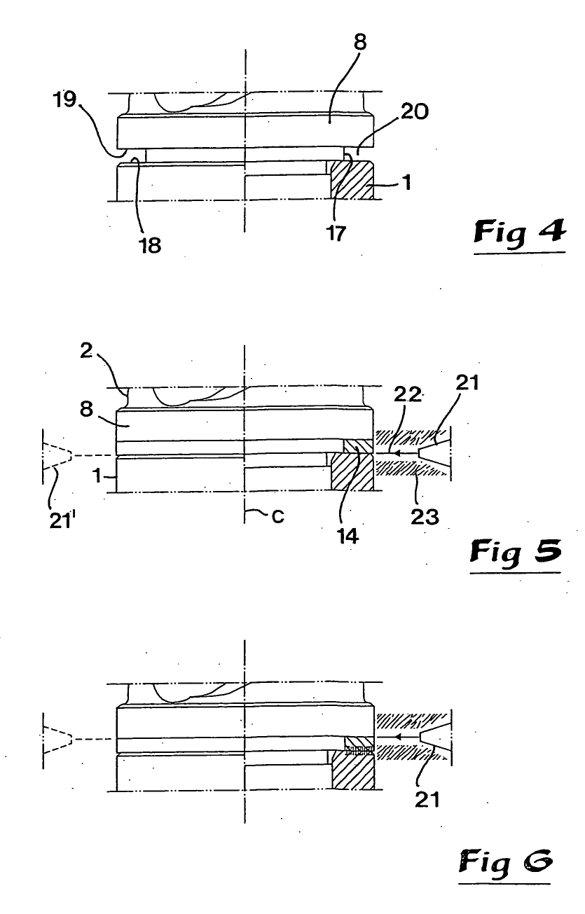

New and characteristic of the tool according to the present invention is that the shank 2 and the coupling part 1, in addition to the shrink fit via said male-female joint 9, 11, are united to each other via a welded joint, which generally is provided by laser welding using a pre-formed shim 14 in the shape of a ring. As is seen in FIGS. 3-5, said spacing ring 14 cooperates with a shoulder 15 formed adjacent to the collar 8 of the shank 2, which is delimited by a planar end surface 16 and a cylindrical envelope surface 17, and which has a diameter that, on one hand, is smaller than the outer diameter of the collar 8 and, on the other hand, is greater than the outer diameter of the cylindrical spigot 9. Upon assembly of the shank and the coupling part, the planar end surface 16 of the shoulder 15 is pressed against a likewise planar, front end or contact surface 18 on the coupling part 1. Outside the shoulder 15, the collar 8 has a ring-shaped, planar contact surface 19, which like the end surface 16 as well as the surface 18 extends perpendicularly to the geometrical centre axis C of the drilling tool. Thus, when the two tool parts are mounted together, a ring-shaped, circumfering gap is formed between the surfaces 19 and 18, which in FIG. 4 is designated 20.

The spacing ring 14 has a flat basic shape so far that the same in addition to two cylindrical, inner and outer edge surfaces, is delimited by two opposite planar surfaces, which are mutually parallel. The outer diameter of the shoulder 15 is substantially equally great as the inner diameter of the ring 14, at the same time as the outer diameter of the ring substantially corresponds to the outer diameter of the collar 8. In other words, the shape of the spacing ring corresponds to the shape of the gap 20. In practice, the spacing ring should have a thickness (i.e., the distance between the opposite, planar surfaces of the ring) of 0.5 to 1.0 mm, e.g. 0.7 mm. In this connection, it should be pointed out that the thickness of the ring does not need to be exactly equal to the width of the gap (i.e., the distance between the contact surfaces 18, 19). Thus, the thickness of the ring may be a few hundredths of millimeter shorter than the width of the gap. In such a way, it is guaranteed that the spacing ring is not exposed to any deforming pressing forces in connection with the establishment of the male-female joint 9, 11.

The spacing ring is generally formed of steel. Experiments that form the basis of the invention have shown that austenitic steel, in particular austenitic steel of the stainless type, i.e., steel that has been alloyed with suitable quantities of chromium and nickel, is particularly well suitable for the purpose.

The Manufacture of the Cutting Tool According to the Invention

When the shank and coupling part of the drill should be united to each other, in a first step the ring 14 is applied outside the male spigot 9, after which the same is pressed into the seating 11, e.g. in a state when the same is widened by heating of the coupling part, this providing a first, conventional permanent joint (heat shrink fit) between the components in question. In the next step, a second permanent joint is provided, viz, the welded joint, between the coupling part and the shank, more precisely in the way that is schematically illustrated in FIGS. 5 and 6. The welding is carried out by means of a schematically shown laser-welding device 21, which emits a laser beam 22 having a variable diameter or spot size. In order to avoid oxidation by the impact of the oxygen of the air, the welding can be carried out in presence of a surrounding protective gas 23. During welding, the laser beam and the drilling tool are movable in relation to each other. In practice, said mobility may be realized in such a way that the laser-welding device 21 is stationary and the tool rotatable in a suitable holder (not shown). The welding is carried out in two operations, a first one of which is illustrated in FIG. 5. In this figure, it is seen that the laser beam 22 is kept radially directed toward the radial contact plane that is present between one side (the bottom side) of the ring 14 and the ring-shaped, planar contact surface 18 on the coupling part 1. In practice, the laser beam 22 may have a diameter of 0.3 mm, the geometrical centre axis of the beam being located in the same radial plane oriented perpendicular to the center axis C that the contact surfaces between the ring 14 and the coupling part 1 are located in. After the laser beam has been directed toward an arbitrary point along the exposed outer periphery of the ring, the tool is caused to rotate, more precisely at a periphery speed of at least 100 mm/s. When the laser beam hits and penetrates into the contact surfaces between the ring and the coupling part 1, the material melts locally in the area of the beam and is welded together. The heat release is, per se, intense in the immediate vicinity of the beam, but because the beam is moved along the periphery of the ring at a comparatively high speed, the total heat release is limited to a minimum, which in no way gives rise to any deformations or material migration in the interface between the shank and the coupling part. When the tool has rotated one revolution (360°) the radiation is interrupted. Welding of the spacing ring 14 against the coupling part 1 is then completed.

In the next operation, the ring 14 is also welded against the shank. As is seen in FIG. 6, the laser beam and the tool are then moved axially in relation to each other, so that the laser beam is located in the same radial plane as the contact surfaces between the ring and the collar 8 of the shank. After this, welding is carried out in the same way, i.e., the tool is rotated one revolution for the beam to melt the material together in a circumfering, endless welding bead, the plane of which is perpendicular to the centre axis C.

As an example, it should be mentioned that welding of a 39 mm drill, which is rotated at a periphery speed of 112 mm/s in relation to the laser beam, can be achieved in 0.7 seconds. Immediately after finalized welding, the weld obtained has substantially room temperature.

To the left in FIGS. 5 and 6, a second laser-beam device 21′ is outlined by means of dashed lines. This device may be placed diametrically opposite the device 21. In this case, a circumfering, ring-shaped weld may be provided by turning the tool only half a revolution, i.e., in half of the time, since each device 21, 21′ will form one-half of the weld.

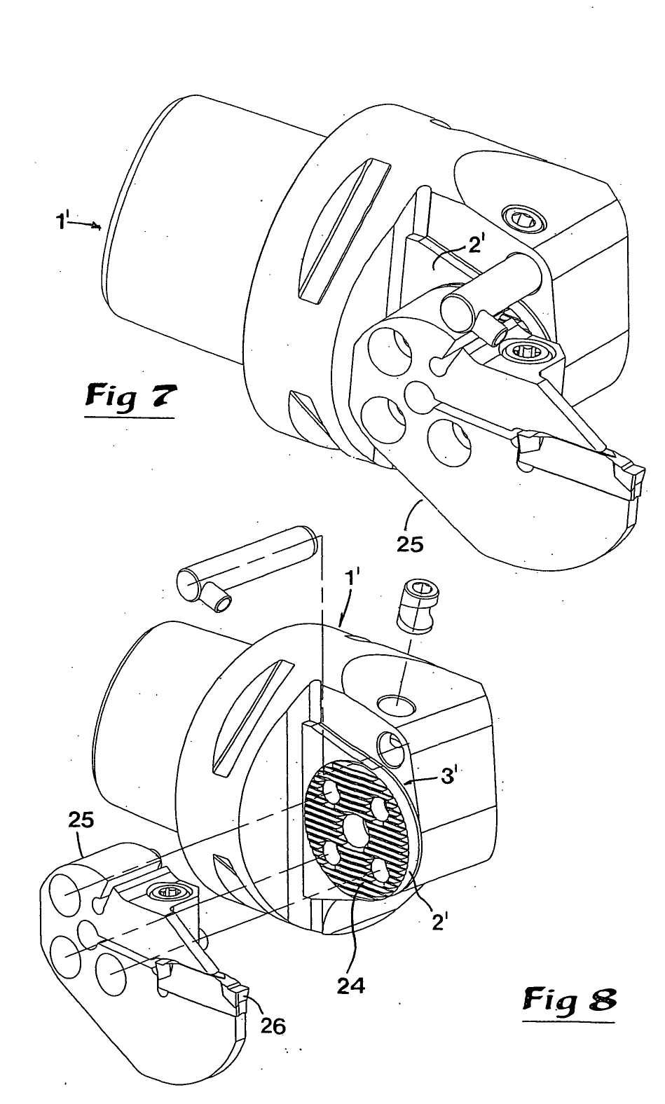

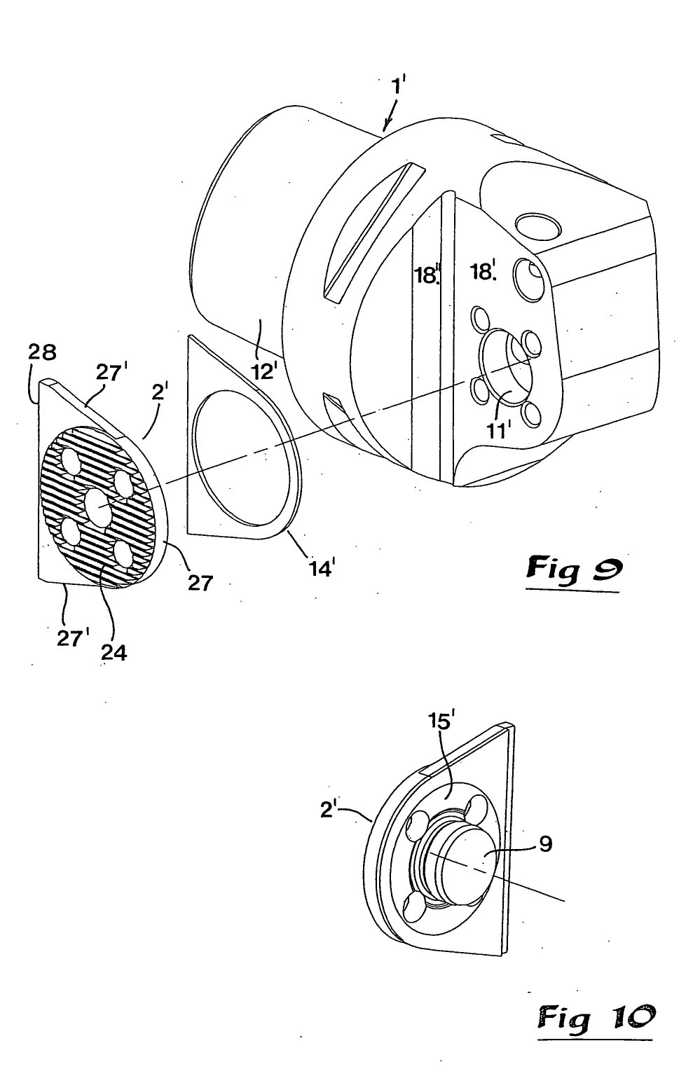

Reference is now made to FIGS. 7-10, which illustrate a cutting tool of fixed type, viz, a turning tool for parting or groove-slotting operations. In this case, the second part, which should be permanently connected to a coupling part 1′, consists of a plate 2′, which is formed with a serration surface 24 arranged to cooperate with an analogous serration surface (not visible) on a detachable holder part 25, in which a releasable so-called slotting tool 26 is included. In the same way as in the drill according to the above, it is of great importance that the serration plate 2′ is united to the coupling part or the adapter 1′ in a way that allows transfer of great forces between the parts, and that guarantees a meticulous location of the serration surface in relation to the coupling part (with the purpose of attaining a correct position setting of the slotting tool 26 in relation to the coupling piece 12′ of the coupling part). In this case, the plate 2′ (see FIG. 9) has a partially circular and partially triangular shape so far that the same is delimited by a partly cylindrical edge surface 27, which transforms into two planar and straight edge surfaces 27′, which extend at a mutual acute angle and which end in a common, rear edge surface 28. The surface 28 is straight and planar and forms a base of an imaginary triangle. On the back side of the plate 2′, a male member 9′ is formed in the form of a cylindrical spigot, which is insertable with press-fit in a corresponding, cylindrical seating 11′ in the coupling part. Thus, the spigot 9′ and the seating 11′ form a male-female joint, which should be supplemented with a welded joint of the above described type. For this purpose, a shim 14′ is arranged between the inside of the plate 2′ and a planar contact surface 18′ on the coupling part, the contour shape of which shim corresponds to the contour shape of the plate 2′. In the shim, there is a cylindrical hole, the inner diameter of which corresponds to the outer diameter on a cylindrical shoulder 15′ (see FIG. 10) formed on the inside of the plate.

When the spigot 9′, upon mounting and fixation of the serration plate 2′, is inserted into the seating 11′, the rear edge 28 of the plate is located in abutment (with a very fine fit) against a second contact surface 18″ formed on the coupling part, which extends perpendicularly to the contact surface 18′. Possibly, but not necessarily, the spigot 9′ can be fixed by heating and shrinkage to form a shrink-fit. Such fixation is, however, incidental as a consequence of the abutment of the edge surface 28 against the second contact surface 18″ making turning of the plate in relation to the coupling part impossible. When the spigot 9′ is inserted, the shim 14′ has been applied against the inside of the plate, so that the shim is abutted in close contact against the contact surface 18′ as well as the inner, planar surface of the plate 2′, as is shown in FIG. 8. In this state, laser welding is carried out in the previously described way, i.e., in two consecutive operations a laser beam is brought to move along the periphery of the shim in two axially spaced-apart planes. In this case, each individual operation may furthermore be divided into a plurality of steps. Thus, in a first step, just one weld may be welded along a linear edge portion 27′, during linear or straight movement of the coupling part in relation to the laser beam. In a second step, the tool is turned in order to provide a weld along the cylindrical edge portion of the plate 2′, and then a third, linear weld along the second edge portion 27′ is provided by again moving the coupling part linearly in relation to the laser beam.

### ADVANTAGES OF THE INVENTION

A fundamental advantage of the method according to the invention is that two metallic parts included in a cutting tool can be welded together via a strong and reliable welded joint during utilization of minimal total heat release in order to carry out the requisite welding or melting process in the material. This means that a predetermined positioning of the parts in relation to each other is not influenced by the welding operation, whereby, for instance, the exact position of an insert-carrying component in relation to a coupling part may be maintained in a reliable way. When applied to rotatable tools of the type drills or milling cutters, the described welding technique may furthermore be utilized with the purpose of shortening tools. Thus, as is best seen in FIG. 3, the length or the axial extension of the male member in the male-female joint of the tool may be reduced to less than half of the diameter of the tool shank. Thus, in the drill in question, the total length of the drill may be reduced by at least the same measure as the drill diameter. In this connection, attention should be paid to the fact that the welded joint is peripheral, i.e., located in an area where drills and milling cutters have the greatest diameter thereof. This means that the force-transferring capacity of the welded joint becomes optimum.

Feasible Modifications of the Invention

The invention is not solely limited to the embodiments described above and shown in the drawings. For instance, the welds obtained need not necessarily be continuous along the entire periphery or outwardly exposed edge of the shim. Thus, during the welding it is feasible to intermittently switch off the laser beam during continued turning or straight movement of the tool in relation to the welding device. In such a way, a welded joint consisting of a plurality of peripherically spaced-apart, spot or patch-like welding points is provided. It should also be mentioned that the spacing ring need not be planar. Thus, it is feasible for example that the ring be of conical shape (e.g., a cup spring washer), the surrounding parts being formed so that the shim-receiving gap has an analogous shape. Furthermore, the method according to the invention may be applied to welding together parts in arbitrary cutting tools other than the parts that have been exemplified in the drawings. Although the described embodiments illustrate external welding, also internal welding is feasible.

1. A method for manufacturing a tool for chip-removing machining, the tool including first and second metallic parts, the method comprising the steps of:
A) positioning a metallic shim within a gap between the first and second parts, such that an outer periphery of the shim is exposed, and
B) performing a laser welding procedure around the exposed outer periphery of the shim to weld the shim to the first and second parts.

2. The method according to claim 1 wherein step B comprises performing a first laser welding operation wherein a laser beam is directed from a first location toward a first contact plane disposed between the shim and one of the first and second parts, and then performing a second laser welding operation wherein a laser beam is directed from a second location toward a second contact plane formed between the shim and the other part.

3. The method according to claim 2 wherein a continuous weld is formed around the periphery of the shim during each of the first and second welding operations.

4. The method according to claim 2 wherein each welding operation is performed in a plurality of steps, wherein the relative motion between the laser beam and the shim are different.

5. The method according to claim 1 wherein a relative speed of at least 100 m/s occurs between the laser beam and the shim during the laser welding procedure.

6. The method according to claim 1 wherein a width of the shim is shorter than a width of the gap.

7. A tool for chip-removing machining comprising a metallic first part, a metallic second part, and a metallic shim disposed in a gap between the first and second parts, the shim having a shape generally corresponding to a shape of the gap, the shim including a first side laser-welded to the first part, and a second opposite side laser-welded to the second part.

8. The tool according to claim 7 wherein at least one of the first and second parts comprises carbon steel, and the shim comprises austenitic steel.

9. The tool according to claim 7 wherein the tool comprises a rotary tool defining an axis of rotation, one of the first and second parts including a projection and the other part including a socket in which the projection is secured by a press-fit.

10. The tool according to claim 9 wherein the shim is ring-shaped.

11. The tool according to claim 10 wherein the shim is flat and includes opposite planar and parallel sides welded to first and second contact surfaces of the first and second parts, respectively, the contact surfaces lying in respective planes oriented perpendicular to the axis of rotation.

12. The tool according to claim 10 wherein one of the first and second parts includes a shoulder engaging the other part to define the gap, the shoulder having a diameter longer than a diameter of the projection and shorter than a largest diameter of the contact surface of the one part on which the shoulder is disposed.

13. The tool according to claim 12 wherein a thickness of the shim is shorter than the width of the gap.
